(19) United States
(12) Patent Application Publication
(10) Pub. No.: US 2026/0268123 A1
(43) Pub. Date: Sep. 10, 2026

(54) ESTIMATION OF ANOMALOUS DATA USING GENERATIVE ADVERSARIAL NETWORK BASED ARCHITECTURE IN A NETWORK

(71) Applicant: Telefonaktiebolaget LM Ericsson (publ), Stockholm (SE)

(72) Inventors: Mohamed NAILI, Montreal (CA); Zhongwen ZHU, Saint-Laurent (CA); Emmanuel THEPIE FAPI, Cote-Saint-Luc (CA)

(21) Appl. No.: 18/871,893

(22) PCT Filed: Apr. 4, 2023
(86) PCT No.: PCT/IB2023/053424

§ 371 Date: Dec. 5, 2024

(30) Foreign Application Priority Data
Jun. 8, 2022 (WO) PCT/IB2022/055335

(51) Int. Cl. G06N 3/0475; G06N 3/094

(52) U.S. Cl. CPC G06N 3/0475; G06N 3/094

(57) ABSTRACT

A computer-implemented method is provided for estimation of anomalous data performed by a computing device including a GAN based architecture in a network. The method includes receiving data; classifying the data as manipulated data or not manipulated data; and when the data is classified as manipulated data, outputting an estimated anomalous data that represents a difference between (i) the data and (ii) the manipulated data. Related methods and apparatus are also disclosed including, optionally, classifying the estimated anomalous data as a type of anomalous data; and outputting the type of anomalous data.

### TECHNICAL FIELD

The present disclosure relates generally to computer-implemented methods for estimation of anomalous data performed by a computing device comprising a generative adversarial network (GAN) based architecture in a network, and related methods and devices.

### BACKGROUND

Anomalous data is a topic of research. An example of anomalous data is Passive Intermodulation (PIM). Generally, PIM refers to “a potential interference source in radio communications systems, which represents the result of two or more signals interacting in a nonlinear device to produce unwanted signals” where “frequencies of intermodulation signals overlap with the receiving band, which increases noise floor and submerge the useful carriers” T. Soares Da Costa, “Characterization of Passive Intermodulation Distortion in MultiBand FDD Radio Systems”, Degree Project In Information and Communication Technology, Second Cycle, Stockholm, Sweden (2019); and Yun Li, et al, “A Novel Simulation Method of Passive Intermodulation in Electrically Large-size Reflector Antennas”, 2018 IEEE International Symposium on Electromagnetic Compatibility and 2018 IEEE Asia-Pacific Symposium on Electromagnetic Compatibility (EMC/APEMC) (2018). PIM can be caused by several sources, and may be categorized into internal (e.g., contact nonlinearities sources, metal-insulator-metal situations in radio frequency (RF) system sources, electro-thermal PIM sources, etc.) or external (e.g., reflection on metal surfaces sources, dielectric coating and wave polarization source, etc.). PIM also can be simulated or generated empirically.

In some approaches, an adversarial network has been adopted that may include anomaly detection. In a GAN, generally, at least a classifier and a generator of adversarial examples compete. On the one hand, the classifier (often referred to as a discriminator), is trained to classify inputs coming from a real data distribution as “real” and inputs generated by a generator (e.g., an adversarial examples generator) as fake. On the other hand, the generator tries to learn how to generate data points that will be labeled as “real” by the discriminator (that is, fool the discriminator). For example, the generator can generate adversarial examples based on a randomly generated input or can be designed as an Auto Encoder (AE) or Variational Auto Encoder (VAE) where the input is a real data point.

Mathematically, this optimization problem can be modeled as follows:

$${min}_{G} {max}_{D} V ( D ; G ) = {E}_{x ∼ p ( x )} ( x ) [ log D ( x ) ] + {E}_{z ∼ p ( z )} ( z ) [ log ( 1 - D ( G ( z ) ) ) ]$$

### Where:

x: a real data point coming from real data distribution p(x)
z: a fake data point coming from another data distribution p(z) learned by the generator

### SUMMARY

There currently exist certain challenges. Some approaches may detect anomalous data without estimating the anomalous data. Such detection without estimating the anomalous data may lack exploitation of the data, such as estimating and classifying the anomalous data.

Certain aspects of the disclosure and their embodiments may provide solutions to these or other challenges.

Some embodiments provide a computer-implemented method for estimation of anomalous data performed by a computing device comprising a GAN based architecture in a network. The method includes receiving data, and classifying the data as manipulated data or not manipulated data. The method further includes, when the data is classified as manipulated data, outputting an estimated anomalous data that represents a difference between (i) the data and (ii) the manipulated data.

Other embodiments provide a computing device. The computing device is configured for estimation of anomalous data in a network. The computing device includes a GAN based architecture; at least one processor; and memory coupled with the at least one processor and GAN based architecture. The memory includes instructions that when executed by the at least one processor causes the computing device to perform operations comprising to receive data, and classify the data as manipulated data or not manipulated data. The operations further include, when the data is classified as manipulated data, to output an estimated anomalous data that represents a difference between (i) the data and (ii) the manipulated data.

Some embodiments provide a non-transitory computer readable medium including program code to be executed by at least one processor of a computing device configured for estimation of anomalous data in a network. Execution of the program code causes the program code to perform operations comprising to receive data, and classify the data as manipulated data or not manipulated data. The operations further include, when the data is classified as manipulated data, to output an estimated anomalous data that represents a difference between (i) the data and (ii) the manipulated data.

Certain embodiments may provide one or more of the following technical advantage(s). Estimating anomalous data can be used to recover original data and classify the anomalous data. For example, if a signal is affected with PIM, then based on detecting and estimating the PIM, the estimated PIM can be used to classify the PIM (e.g., one or more of internal PIM: contact nonlinearities sources, metal-insulator-metal situations sources, electro-thermal PIM sources, external PIM: reflection on metal surfaces sources, dielectric coating and wave polarization source, etc.) and to recover the original signal. In estimating the anomalous data, instead of making a ML model learn how to output a similar data (like an autoencoder, for example) to the original one, and then compare and calculate the difference between this output and the input, a GAN based architecture learns to output the difference between manipulated data and original data. As a consequence, a burden of keeping track of inputs for comparison may be eliminated. Moreover, the difference can be used to recover the original data and calculate an anomalous data severity and also can be used to classify the anomalous data. Additional technical advantages may include that estimating the severity may help in assessing the quality of data, equipment, and deployment, for example.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a schematic diagram illustrating a GAN based architecture in accordance with some embodiments;

FIG. 2 is a schematic diagram of an example of training for classification and estimated anomalous data generation by a discriminator in accordance with some embodiments;

FIG. 3 is a schematic diagram of an example of training a classifier in accordance with some embodiment;

FIG. 4 is a schematic drawing illustrating a component for data recovery in accordance with some embodiments;

FIG. 5 is a schematic diagram of an example of predicting an input data class and its associated estimated anomalous data in accordance with some embodiments;

FIG. 6 is a flowchart illustrating example operations of a computing device in accordance with some embodiments;

FIG. 7 is a flowchart illustrating operations of a computing device according to some embodiments;

FIG. 8 is a block diagram of computing device according to some embodiments; and

FIG. 9 is a block diagram of a communication system in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

As previously referenced, there exist certain challenges. Some approaches may detect an anomalous data without estimating the anomalous data. Such detection without estimating the anomalous data may lack exploitation of the data, such as estimating and classifying the anomalous data.

Certain aspects of the disclosure and their embodiments may provide solutions to these or other challenges.

Examples of the present disclosure include use of a GAN-based architecture to teach a discriminator not only to detect anomalous data, but also to estimate the anomalous data, such estimation can be used to recover the original data. Additionally, the severity of the anomalous data can be calculated and the anomalous data can be classified.

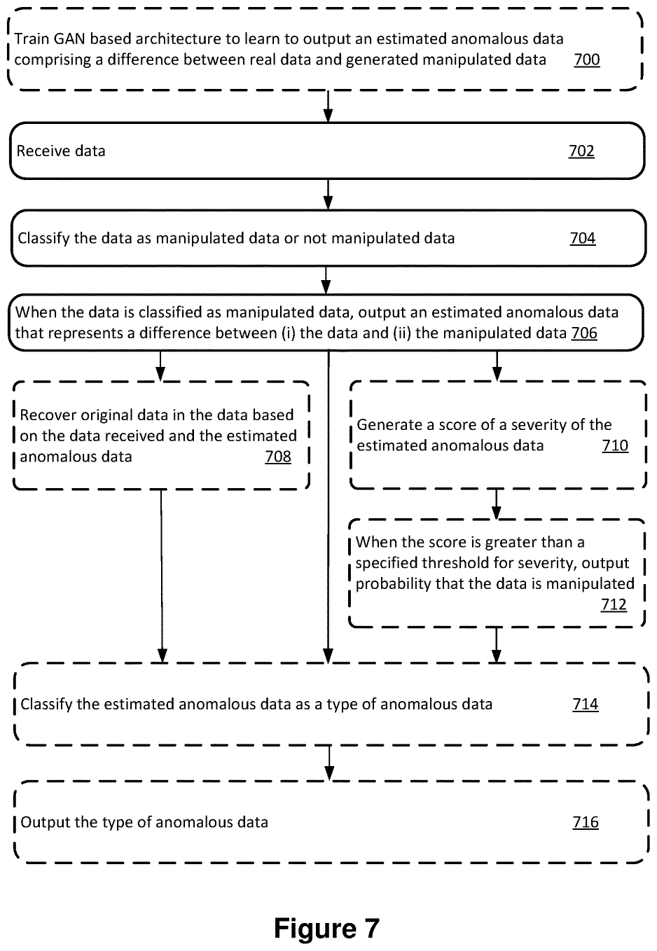

In some embodiments, a computer-implemented method is provided for estimation of anomalous data performed by a computing device including a GAN based architecture in a network. The method includes receiving (operation 702 in FIG. 7) data, and classifying (operation 704 in FIG. 7) the data as manipulated data or not manipulated data. The method further includes, when the data is classified as manipulated data, outputting (operation 706 in FIG. 7) an estimated anomalous data that represents a difference between (i) the data and (ii) the manipulated data. As discussed further herein, in some embodiments, the method further includes training, and the training includes data classification and estimated anomalous data prediction.

Examples of the present disclosure are discussed in the non-limiting context of anomalous data comprising PIM. The present disclosure is not limited to PIM, however, and includes any other type of anomalous data in a network. As referred to herein, the term “anomalous data” refers to data that includes an aberration, fault, deviation, abnormality, error, deficiency, undesirable data, etc.

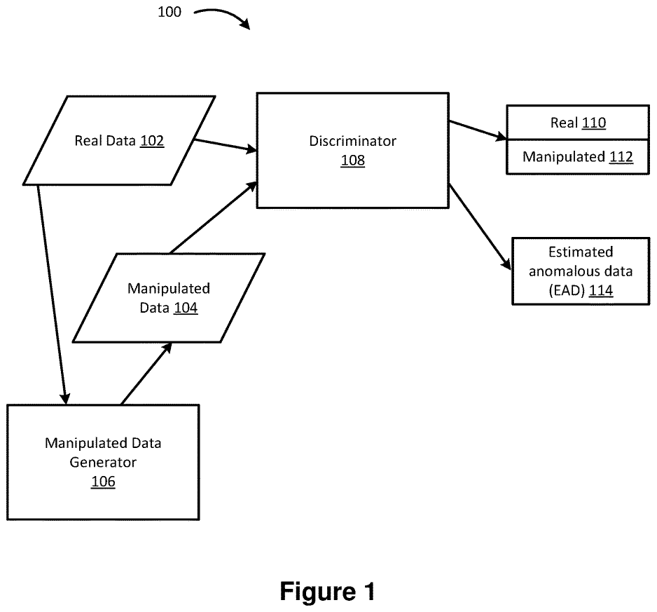

FIG. 1 is a schematic diagram illustrating a GAN based architecture 100 in accordance with some embodiments.

The architecture 100 of FIG. 1 deals with two types of data of the same shape: real data 102 and manipulated data 104. In some embodiments, the data includes a first data shape that includes a first number of dimensions in the data as a first vector and the estimated anomalous data includes a second data shape that includes a second number of dimensions in the estimated anomalous data as a second vector.

Real data 102 can include collected and preprocessed data (e.g., data cleansing, features selection and engineering if needed, normalizing/standardizing if needed, etc.). Real data 102, however, may not be preprocessed data. The manipulated data 104 is the output of manipulated data generator 106. The manipulated data generator 106 can be an encoder-decoder or variational encoder-decoder based generator, for example. Manipulated data generator 106 can generate adversarial data 104 (that is, manipulated data) based on real data 102.

In an example for PIM, subframes are an input, an antenna system with three ports, and a resource block (RB) of 1 slot with 12 subcarriers (e.g., 1 Slot (0.5 ms)=7 Symbols), can be represented with 3 timeseries. If the subframes are sampled by 1 second, then a data point representing the antenna in 1 second has the shape: (900, 2, 7, 12, 3).

In this example, manipulated data generator 106 can be a machine learning (ML)-based model or a physical model used to generate a specific type of PIM (for example: Internal PIM: design PIM, assembly PIM. External: such as rusty bolt PIM). Such manipulated data generator 106 can be tunable based on a “generator loss” as explained further herein.

FIG. 1 further includes discriminator 108. Discriminator 108 can classify an input data point(s) as either real data 110 or manipulated data 112. In some embodiments, the outputting (operation 706 in FIG. 7) further includes outputting a probability that the data is real data or manipulated data. Additionally, discriminator 108 outputs estimated anomalous data (EAD) 114 which represents the anomalous data.

In some embodiments, the method further includes training (operation 700 in FIG. 7) the GAN based architecture to learn to output an estimated anomalous data including a difference between real data and generated manipulated data. Further, in some embodiments, training (operation 700 in FIG. 7) the GAN-based architecture to output the estimated anomalous data is based on (i) inputting data including at least one of real data and manipulated data, (ii) making a classification of the data as one of real data or manipulated data, and (iii) calculating a classification loss for the classification based on a known label for the generated manipulated data. The generated manipulated data can be generated by the generator of the GAN based architecture that receives the real data.

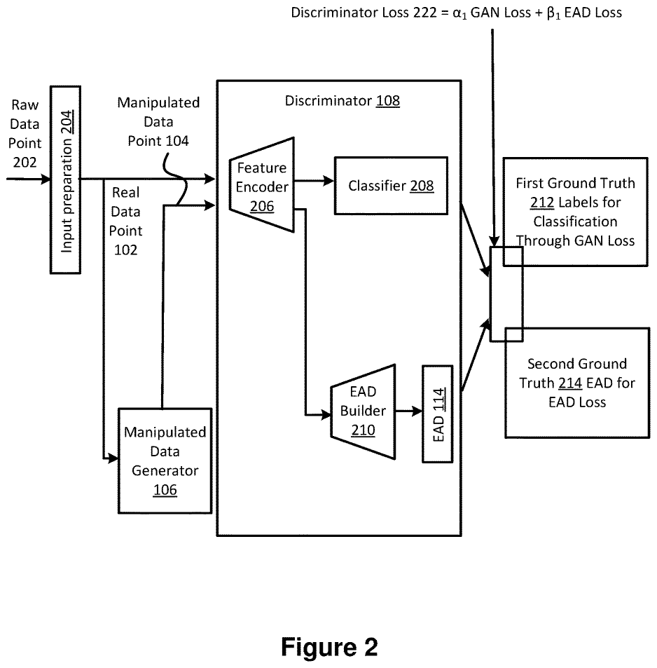

For example, during training, if the input data 102 shape is of shape S (e.g., input data of shape S is referred to as D^{S}), then a first ground truth (212 in FIG. 2) for classification through GAN loss can be given in terms of an “expected label” and “expected EAD” as follows:
If Input=real data point:

$$Expected label = Real$$

$$Expected EAD = {0}^{S}$$

If Input=Manipulated data point:

$$Expected label = Manipulated point$$

Expected EAD=F(Manipulated Data, Real Data) where F is a function such as a feature-feature difference between these two data point.

In some embodiments, during training (operation 700 in FIG. 7), the GAN based architecture receives the real data having a first shape and uses a first ground truth including (i) when a data point in the real data is identified as real data, the expected label for the real data point is real and an expected estimated anomalous data has a value of zero based on a lack of difference between the first shape and a second shape of the generated manipulated data, and (ii) when a data point in the real data is identified as the generated manipulated data, the expected label for the generated manipulated data point is manipulated point and the expected estimated anomalous data is a function of the difference between the real data and the generated manipulated data.

In other embodiments, training (operation 700 in FIG. 7) further includes building a loss function to train the discriminator and the generator of the GAN based architecture based on a discriminator loss including a GAN loss related to a classification loss of the discriminator and an estimated anomalous data loss including a distance between an expected estimated anomalous data and the outputted estimated anomalous data.

For example, GAN loss is related to classification loss of the discriminator (such as Wasserstein loss function (see e.g., Adversarial Discriminative Attention for Robust Anomaly Detection, Daiki Kimura, 2020 IEEE Winter Conference on Applications of Computer Vision (WACV), 10.1109/WACV45572.2020.9093428 (1-5 Mar. 2020) or another classification loss function). EAD loss is related to a distance between the expected EAD and the predicted EAD (such as Euclidean distance or cosine distance):

EAD loss=distance(expected EAD,predicted EAD)

Based on the GAN and EAD losses, a loss function (222 if FIG. 2) can be built to train the discriminator 108 and the manipulated data generator 106 as follows:

$$Discriminator loss = {α}_{1} GAN Loss + {β}_{1} EAD Loss$$

Manipulated data generator 106 loss in this example is:
If Input=Manipulated Data:

$${L}_{1} = {α}_{2} GAN Loss + {β}_{2} EAD Loss$$

$$Manipulated Data Generator 106 loss = \{ \begin{matrix}- {L}_{1} \\ Or \\ γ1 , if {L}_{1} = 0 where {γ}_{1} is a predefined minimum loss\end{matrix}$$

FIG. 2 is a schematic diagram of an example of training for classification and estimated anomalous data generation by a discriminator in accordance with some embodiments.

In the example in FIG. 2, a raw data point 202 is processed in input preparation 204 (e.g., data cleansing, features selection and engineering if needed, normalizing/standardizing if needed, etc.). The resulting real data point 102 is input to discriminator 108 and to manipulated data generator 106.

Feature encoder 206 of discriminator 108 receives real data point 102 and extracts a feature(s) (e.g., variables or attributes) from the real data point 102. The extracted feature(s) is provided as input to classifier 208 and EAD builder 210. Classifier 208 classifies the feature(s) as either a probability that the feature(s) is real data 110 or a probability that the feature(s) is manipulated data 112 according to the first ground truth 212 labels for classification through GAN loss, as previously discussed herein.

Additionally, EAD builder 210 outputs EAD 114 which represents the anomalous data. During training, a second ground truth 214 for EAD 114 for EAD loss can be given in terms of the following:
If EAD=0

$$Expected label = Real data point$$

If EAD=F(Manipulated data point, real data point)

$$Expected label = Manipulated data point$$

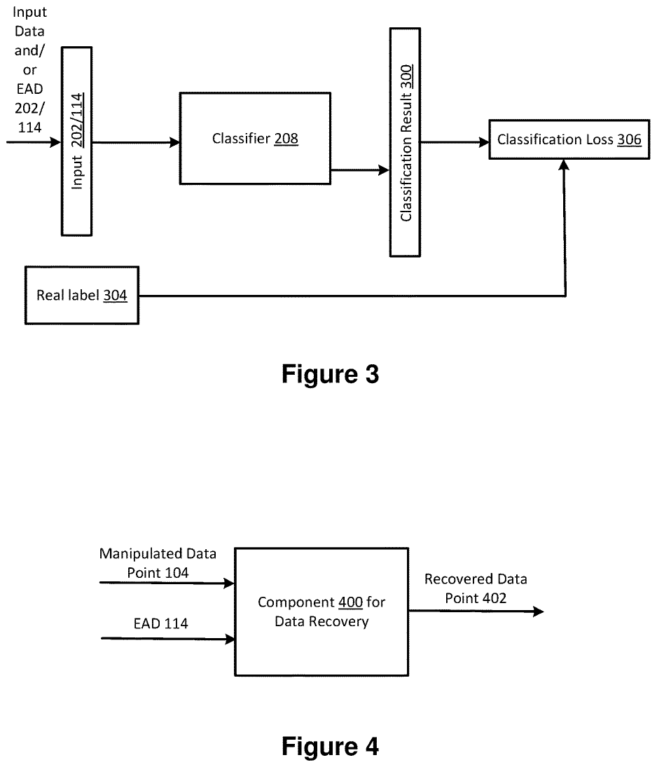

FIG. 3 is a schematic diagram of an example of training classifier 208 in accordance with some embodiments. In some embodiments, training (operation 700 in FIG. 7) further includes training a classifier in the discriminator of the GAN based architecture based on inputting the real data and/or the estimated anomalous data to the classifier and outputting a classification distribution. In an example, classifier 208 is trained based on input data 202 or/and EAD 114 as input and a classification distribution result 300 as an output. During training, the real label 304 of the generated anomaly is already known (for example, generate rusty bolt PIM, this means the true label is “rusty bolt PIM” and the classifier should learn to give the highest probability to the output corresponding to “rusty bolt PIM”). Anomalous data classification loss 306 can be cross entropy or any other suitable loss function.

In some embodiments, the method further includes recovering (operation 708 in FIG. 7) original data in the data based on the data received and the estimated anomalous data. The data received and the estimated anomalous data respectively include a plurality of features and the recovering (708) includes a difference between the data received and the estimated anomalous data, and (ii) using a ML based model that receives the estimated anomalous data and the manipulated data and outputs the recovered original data.

For example, recovered data can be calculated as follows:

$$Recovered data = C ( Input Data , EAD )$$

where C is a function that can be used to recover data based on input data 202 and EAD 114. C can be a feature-feature difference between these two data points. However, due to the non-linearity nature of many real-life applications, such a function for C may not recover the original data point. Thus, in another example as shown in FIG. 4, a component 400 comprising neural network-based data recovery model (e.g., based on an encoder-decoder architecture) can be trained and used to output recovered data point 402 based a third ground truth (real data point) for data recovery loss: Data recovery loss=Distance (Recovered data point, real data point). Training of such a ML model can be based on EAD 114/manipulated data point(s) 104 produced by trained discriminator 108 and trained generator 106, respectively.

In an inference phase, the discriminator 108 can classify the input data 202 and output an EAD 114.

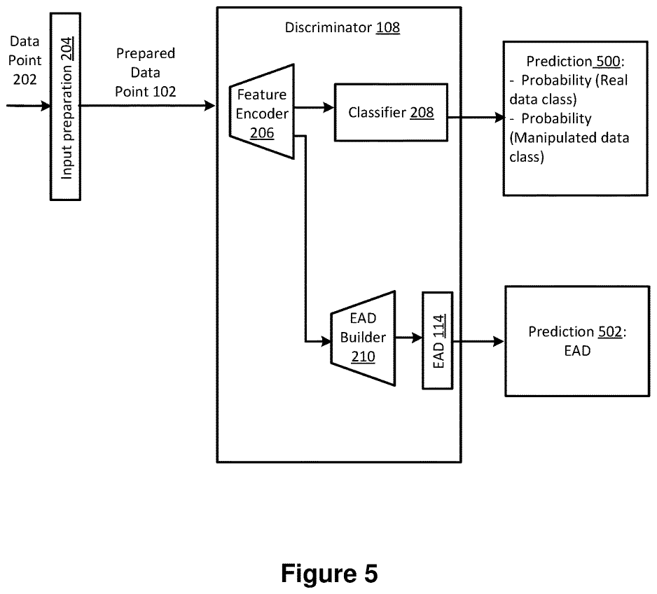

For example, FIG. 5 is a schematic diagram of an example of predicting 500 an input data class and predicting 502 its associated EAD in accordance with some embodiments. In FIG. 5, an incoming data point 202 is processed in input preparation 204 (e.g., data cleansing, features selection and engineering if needed, normalizing/standardizing if needed, etc.). The resulting real data point 102 is input to discriminator 108.

Feature encoder 206 of discriminator 108 receives real data point 102 and extracts a feature(s) (e.g., variables or attributes) from the real data point 102. The extracted feature(s) is provided as input to classifier 208 and EAD builder 210. Classifier 208 classifies the feature(s) as either a probability that the feature(s) is real data 110 or a probability that the feature(s) is manipulated data 112.

In some embodiments, the probability includes at least one of (i) the data is real data when a value of the probability is less than or equal to a specified threshold value, and (ii) the data is manipulated data when the value of the probability is greater than the specified threshold value.

For example, in the example in FIG. 5:
If Probability (Manipulated data class)<=manipulated threshold (predefined/specified threshold), then the input data is considered as benign data (not manipulated)
If Probability (Manipulated data class)>manipulated threshold (predefined/specified threshold), then recovered data can be used as a denoised/anomaly-free data

Additionally, EAD builder 210 outputs EAD 114 which represents the anomalous data.

In some embodiments, the method further includes generating (operation 710 in FIG. 7) a score of a severity of the estimated anomalous data. The generating includes using the following calculation,

$$score = ( \frac{DWMAED}{max\_WMAED} )$$

where (i) WMAED is a weighted mean absolute estimated distortion that is equal to a matrix of weights of features of the first data shape multiplied by the estimated anomalous data, (ii) max_WMAED is a specified maximum value of WMAED, and (iii) DWMAED is a double weighted mean absolute estimated distortion that is equal to a probability that the data is manipulated multiplied by WMAED.

For example, using a matrix of features importance (e.g., weights W) of the shape of the input data 102, a Hadamard-product: W o EAD can be used to calculate the Weighted Mean Absolute Estimated Distortion (WMAED):

$$WMAED = Mean ( Abs ( W ∘ EAD ) )$$

W can be generated using an explainability algorithm (such as shapley additive explanation (SHAP), local interpretable model-agnostic explanations (LIME), etc.) for feature importance on a ML model of the discriminator 108.

As a classification output probabilities sum is equal to 1:

$$P ( Manipulated ) = 1 - P ( real )$$

If max_WMAED is a predetermined maximum value of WMAED, the Double Weighted Mean Absolute Estimated Distortion (DWMAED) is as follows:

$$DWMAED = P ( Manipulated ) \times WMAED$$

Then the severity score of the anomalous data can be calculated as follows:

$$Severity score = \frac{DWMAED}{max\_WMAED}$$

For example, if the severity score has a maximum value of 1:

$$Severity score = Min ( 1 , \frac{DWMAED}{max\_WMAED} )$$

In some embodiments, when the score is greater than a specified threshold for severity, the method further includes outputting (operation 712 in FIG. 7) the probability that the data is manipulated. For example, if the severity score>specified severity threshold, then an anomaly can be reported with a probability P(Manipulated).

In other embodiments, the method further includes classifying (operation 714 in FIG. 7) the estimated anomalous data as a type of anomalous data; and outputting (operation 716 in FIG. 7) the type of anomalous data.

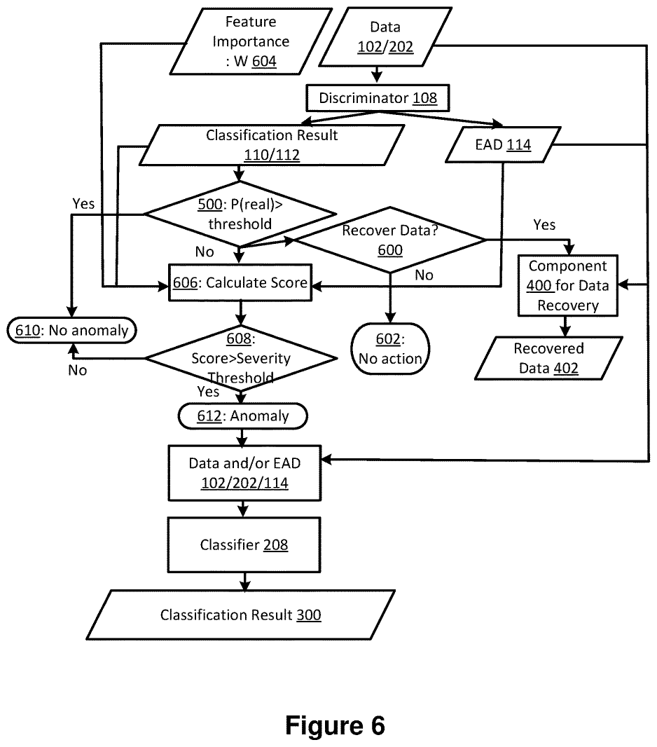

FIG. 6 is a flowchart illustrating example operations of a computing device in accordance with some embodiments. FIG. 6 illustrates applying a trained discriminator 108 and the component 400 for data recovery to datapoints 102, 202 for anomalous data detection and classification 110, 112, a corresponding severity score calculation 606, 608, and classification 614, 616 of the anomalous data.

In the example in FIG. 6, an incoming data point 102/202 is input to discriminator 108. Based on the received data point 102/202, discriminator 108 outputs a classification result 300 and EAD 114, as previously discussed herein. The classification result 300 includes a probability 500 that the input data 102/202 is or is not an anomaly. If Probability 500<=manipulated threshold (predefined/specified threshold), then the input data 102/202 is considered as benign data (no anomaly 610), a determination 600 is made not to recover data, and no action 602 is taken. If the probability 500>manipulated threshold (predefined/specified threshold), then the input data 102/202 is considered as an anomaly, a severity score is calculated 606, a determination 600 is made to recover data with component 400.

Additionally, discriminator 108 outputs EAD 114, as previously discussed.

In FIG. 6, the score is calculated 606 using a matrix of features importance, weights W 604, of the shape of the input data 102/202, and a Hadamard-product: W 604 o EAD 114 is used to calculate the Weighted Mean Absolute Estimated Distortion (WMAED):

$$WMAED = Mean ( Abs ( W ∘ EAD ) )$$

As previously discussed, W 604 can be generated using an explainability algorithm (such as SHAP, Lime, etc.) for feature importance on the discriminator 108 ML model.

As previously discussed, a classification output probabilities sum is equal to 1:

$$P ( Manipulated ) = 1 - P ( real )$$

If max_WMAED is a predetermined maximum value of WMAED, the Double Weighted Mean Absolute Estimated Distortion (DWMAED) is as follows:

$$DWMAED = P ( Manipulated ) \times WMAED$$

Then the score 608 of the anomalous data is calculated in FIG. 6 as follows: Score=DWMAED/(max_WMAED. For example, if Score has a maximum value of 1, then:

$$score = Min ( 1 , DWMAED / ( max\_WMAED ) )$$

If the score>specified severity threshold, then anomaly 612 can be reported with a probability P(Manipulated).

In the example in FIG. 6, as previously discussed, a determination is made whether to recover original data based on the probability 500: if probability 500 is no anomaly, there is no action 602; and if probability 500 is anomaly, original data is recovered 402 using component 400 for data recovery, as previously discussed.

In FIG. 6, if anomaly 612 is reported, data 102/202 and/or EAD 114 is input to classifier 208, and classifier 208 outputs a classification result 300 identifying a type of anomalous data for the anomaly 612 (e.g., a highest probability that the anomaly 612 is “rusty bolt PIM”).

In some embodiments, the GAN based architecture includes (i) in training, a generator to generate manipulated data and a discriminator to output the estimated anomalous data and a classification of input data to the discriminator as one of real data and manipulated data, and (ii) in operation of a trained GAN based architecture, a discriminator including a feature encoder to encode at least one feature of input data to the discriminator, a classifier to output a classification of the encoded at least one feature as real data or the manipulated data, a component that generates and outputs the estimated anomalous data, and a component to recover data based on the input data and the estimated anomalous data.

The network can include a telecommunication network. In some embodiments, the anomalous data includes PIM data.

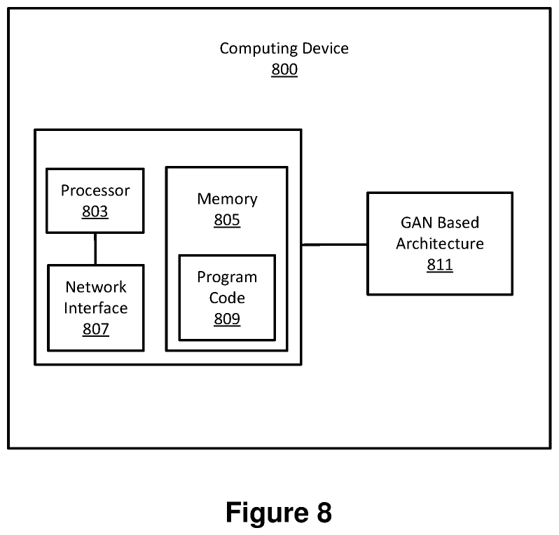

The GAN based architecture of examples herein can be located in a computing device 800 as shown in FIG. 8. The computing device can include at least one of a network node, a computer, and a server. Operations of the computing device (implemented using the structure of FIG. 8) have been discussed with reference to the flow chart of FIG. 7 according to some embodiments of the present disclosure. Operations 700 and 708-716 from the flow chart of FIG. 7 may be optional with respect to some embodiments of computing devices and related methods. Modules may be stored in memory 805 and/or GAN based architecture 811 of FIG. 8, for example, and these modules may provide instructions so that when the instructions of a module are executed by respective computing device processor 803 (also referred to herein as processing circuitry), computing device 800 performs respective operations of the flow chart of FIG. 7.

As shown in FIG. 8, the computing device 800 includes processor 803 that is operatively coupled to memory 805, network interface 807, GAN based architecture 811, and/or any other component, or any combination thereof. Certain computing devices may utilize all or a subset of the components shown in FIG. 8. The level of integration between the components may vary from one computing device to another computing device. Further, certain computing devices may contain multiple instances of a component, such as multiple processors, memories, etc.

The processor 803 is configured to process instructions and data and may be configured to implement any sequential state machine operative to execute instructions stored as machine-readable computer programs in the memory 805 and/or GAN based architecture 811. The processor 803 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 803 may include multiple central processing units (CPUs).

In the example, the network interface 807 may be configured to provide an interface or interfaces to an input device, output device, or one or more input and/or output devices. Examples of an output device include a display, a monitor, a printer, another output device, or any combination thereof. An input device may allow a user to capture information into the computing device 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, a force sensor, an optical sensor, a proximity sensor, a biometric sensor, etc., or any combination thereof. An output device may use the same type of interface port as an input device. For example, a Universal Serial Bus (USB) port may be used to provide an input device and an output device.

The memory 805 and/or GAN based architecture 811 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 805 and/or GAN based architecture 811 includes one or more application programs, such as an operating system, web browser application, a widget, gadget engine, or other application, and corresponding data. The memory 805 and/or GAN based architecture 811 may store, for use by the computing device 800, any of a variety of various operating systems or combinations of operating systems.

The memory 805 and/or GAN based architecture 811 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 805 and/or GAN based architecture 811 may allow the computing device 800 to access instructions, application programs and the like, stored on transitory or non-transitory memory media, to off-load data, or to upload data. An article of manufacture, such as one utilizing a communication system may be tangibly embodied as or in the memory 805 and/or GAN based architecture 811 which may be or comprise a device-readable storage medium.

The processor 803 may be configured to communicate with a network using the network interface 807. The network interface 807 may comprise one or more communication subsystems. The network interface 807 may include one or more transceivers used to communicate, such as by communicating with one or more remote transceivers of another device capable of wireless communication (e.g., another computing device, local computing device, edge node, cloud node, etc.). Each transceiver may include a transmitter and/or a receiver appropriate to provide network communications (e.g., optical, electrical, and so forth).

In the illustrated embodiment, communication functions of the network interface 807 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Functions implemented by some embodiments may be virtualized. In the present context, virtualizing means creating virtual versions of apparatuses or computing devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more VMs implemented in one or more virtual environments hosted by one or more of hardware nodes, such as a hardware computing device that operates as an edge node or cloud node. Further, in embodiments the virtual node may be entirely virtualized.

Applications (which may alternatively be called software instances, virtual appliances, network functions, virtual nodes, virtual network functions, etc.) can be run in the virtualization environment to implement some of the features, functions, and/or benefits of some of the embodiments disclosed herein.

Although the computing device described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the computing device, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processor and the network interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In certain embodiments, a computing device (800, 910) is provided. The computing device is) configured for estimation of anomalous data in a network. The computing device includes a GAN based architecture (811); at least one processor (803); and memory (805) coupled with the at least one processor and GAN based architecture. The memory includes instructions that when executed by the at least one processor causes the computing device to perform operations. The operations include to perform some or all of the functionality described herein.

In certain embodiments, a non-transitory computer readable medium (805) including program code (809) to be executed by at least one processor (803) of a computing device (800, 910) is configured for estimation of anomalous data in a network. Execution of the program code causes the program code to perform operations. The operations include to perform some or all of the functionality described herein.

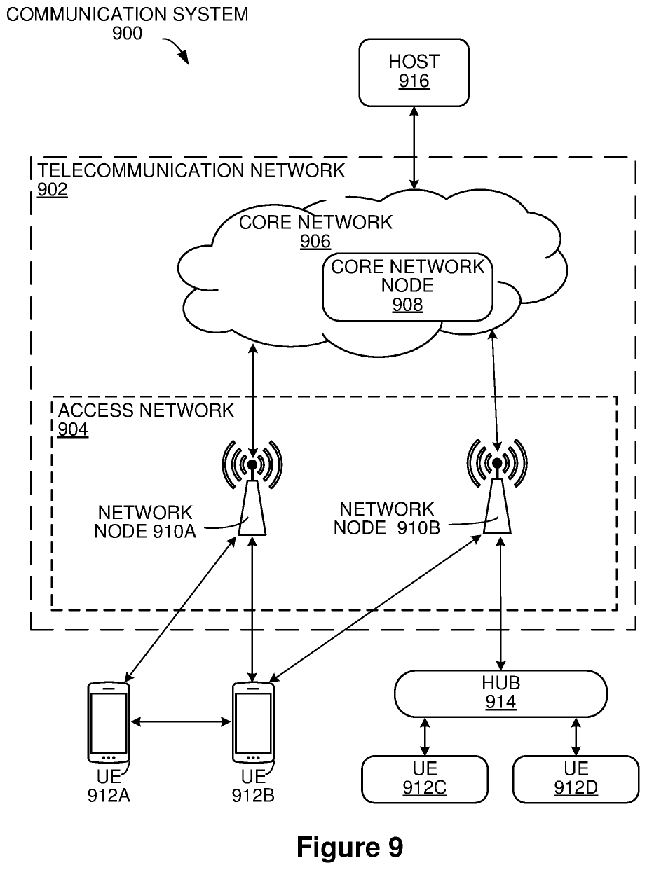

FIG. 9 shows an example of a communication system 900 in accordance with some embodiments.

In the example, the communication system 900 (also referred to herein as a communication network) includes a telecommunication network 902 that includes an access network 904, such as a RAN, and a core network 906, which includes one or more core network nodes 908. The access network 904 includes one or more access network nodes, such as network nodes 910a and 910b (one or more of which may be generally referred to as network nodes 910), or any other similar 3GPP access node or non-3GPP access point. The network nodes 910 facilitate direct or indirect connection of user equipment (UE) (also referred to herein as “user device”), such as by connecting UEs 912a, 912b, 912c, and 912d (one or more of which may be generally referred to as UEs 912) to the core network 906 over one or more wireless connections. A computing device (e.g., computing device 300, 900) can be a network node 910, a UE 912, or another node comprising a computing device in communication system 900.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide URLLC services to some UEs, while providing eMBB services to other UEs, and/or mMTC/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

Further definitions and embodiments are discussed below.

In the above-description of certain embodiments of the present disclosure, it is to be understood that the terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art to which concepts of the present disclosure belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of concepts of the present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the present disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of present disclosure. Accordingly, the above disclosed subject matter is to be considered illustrative, and not restrictive, and the examples of embodiments are intended to cover all such modifications, enhancements, and other embodiments, which fall within the spirit and scope of the present disclosure. Thus, to the maximum extent allowed by law, the scope of the present disclosure is to be determined by the broadest permissible interpretation of the present disclosure including the examples of embodiments and their equivalents, and shall not be restricted or limited by the foregoing detailed description.

1. A computer-implemented method for estimation of anomalous data performed by a computing device comprising a generative adversarial network, GAN, based architecture in a network, the method comprising:
receiving data;
classifying the data as manipulated data or not manipulated data; and
when the data is classified as manipulated data, outputting an estimated anomalous data that represents a difference between (i) the data and (ii) the manipulated data.

2. The method of claim 1, wherein the data comprises a first data shape that comprises a first number of dimensions in the data as a first vector and the estimated anomalous data comprises a second data shape that comprises a second number of dimensions in the estimated anomalous data as a second vector.

3. The method of claim 1, wherein the outputting further comprises outputting a probability that the data is real data or manipulated data.

4. The method of claim 3, wherein the probability comprises at least one of (i) the data is real data when a value of the probability is less than or equal to a specified threshold value, and (ii) the data is manipulated data when the value of the probability is greater than the specified threshold value.

5. The method of claim 1, further comprising:
recovering original data in the data based on the data received and the estimated anomalous data.

6. The method of claim 5, wherein the data received and the estimated anomalous data respectively comprise a plurality of features and the recovering comprises a difference between the data received and the estimated anomalous data, and (ii) using a ML based model that receives the estimated anomalous data and the manipulated data and outputs the recovered original data.

7. The method of claim 2, further comprising:
generating a score of a severity of the estimated anomalous data, wherein the generating comprises using the following calculation
$$score = \frac{DWMAED}{max\_WMAED}$$
where (i) WMAED is a weighted mean absolute estimated distortion that is equal to a matrix of weights of features of the first data shape multiplied by the estimated anomalous data, (ii) max_WMAED is a specified maximum value of WMAED, and (iii) DWMAED is a double weighted mean absolute estimated distortion that is equal to a probability that the data is manipulated multiplied by WMAED.

8. The method of claim 7, wherein when the score is greater than a specified threshold for severity, the method further comprising:
outputting the probability that the data is manipulated.

9. The method of claim 1, further comprising:
classifying the estimated anomalous data as a type of anomalous data; and
outputting the type of anomalous data.

10. The method of claim 1, wherein the GAN based architecture comprises (i) in training, a generator to generate manipulated data and a discriminator to output the estimated anomalous data and a classification of input data to the discriminator as one of real data and manipulated data, and (ii) in operation of a trained GAN based architecture, a discriminator comprising a feature encoder to encode at least one feature of input data to the discriminator, a classifier to output a classification of the encoded at least one feature as real data or the manipulated data, a component that generates and outputs the estimated anomalous data, and a component to recover data based on the input data and the estimated anomalous data.

11. The method of claim 1, further comprising:
training the GAN based architecture to learn to output an estimated anomalous data comprising a difference between real data and generated manipulated data.

12. The method of claim 11, further comprising:
training the GAN-based architecture to output the estimated anomalous data is based on (i) inputting data comprising at least one of real data and a generated manipulated data, (ii) making a classification of the data as one of real data or manipulated data, and (iii) calculating a classification loss for the classification based on a known label for the generated manipulated data.

13. The method of claim 10, wherein the generated manipulated data is generated by the generator of the GAN based architecture that receives the real data.

14. The method of claim 10, wherein during training the GAN based architecture receives the real data having a first shape and uses a first ground truth comprising (i) when a data point in the real data is identified as real data, the expected label for the real data point is real and an expected estimated anomalous data has a value of zero based on a lack of difference between the first shape and a second shape of the generated manipulated data, and (ii) when a data point in the real data is identified as the generated manipulated data, the expected label for the generated manipulated data point is manipulated point and the expected estimated anomalous data is a function of the difference between the real data and the generated manipulated data.

15. The method of claim 10, wherein the training further comprises building a loss function to train the discriminator and the generator of the GAN based architecture based on a discriminator loss comprising a GAN loss related to a classification loss of the discriminator and an estimated anomalous data loss comprising a distance between an expected estimated anomalous data and the outputted estimated anomalous data.

16. The method of claim 10, wherein the training further comprises training a classifier in the discriminator of the GAN based architecture based on inputting the real data and/or the estimated anomalous data to the classifier and outputting a classification distribution.

17. The method of claim 1, wherein the network comprises a telecommunication network.

18. The method of claim 1, wherein the anomalous data comprises passive intermodulation, PIM, data.

19. The method of claim 1, wherein the computing device comprises at least one of a network node, a computer, and a server.

20. A computing device configured for estimation of anomalous data in a network, the computing device comprising:
a generative adversarial network, GAN, based architecture;
at least one processor;
memory coupled with the at least one processor and GAN based architecture, wherein the memory includes instructions that when executed by the at least one processor causes the computing device to perform operations comprising:
receive data;
classify the data as manipulated data or not manipulated data; and
when the data is classified as manipulated data, output an estimated anomalous data that represents a difference between (i) the data and (ii) the manipulated data.

21.-23. (canceled)
